(19) United States
(12) Patent Application Publication
(10) Pub. No.: US 2011/0081945 A1
(43) Pub. Date: Apr. 7, 2011

(54) High Efficiency Laser Drive Apparatus

(75) Inventors: Bruce C. Rothaar, Woodinville, WA (US); Mark Champion, Kenmore, WA (US)

(73) Assignee: MICROVISION, INC., Redmond, WA (US)

(21) Appl. No.: 12/574,307

(22) Filed: Oct. 6, 2009

(51) Int. Cl. H04M 1/00; H02J 3/00; H02J 1/00; H01S 3/00

(52) U.S. Cl. 455/556.1; 307/80; 372/38.02

(57) ABSTRACT

A laser drive apparatus includes a plurality of transistors coupled to different power supply voltages. A control circuit selects one of the plurality of transistors to drive a light source. The control circuit also determines a pulse width to drive the selected transistor. A calibration feedback circuit may be used to calibrate power supplies that provide the different power supply voltages. A dither circuit may be used to reduce the number of bits received by the control circuit.

### FIELD

The present invention relates generally to driver circuits, and more specifically to driver circuits suitable to drive laser light sources.

### BACKGROUND

Direct modulation of laser diodes for video applications is typically performed using Class A amplifiers in which a series pass transistor varies the current supplied to the laser diode. Class A amplifiers are typically not very power efficient because much of the system power is dissipated by the series transistor. This inefficiency results in wasted power consumption which increases heat and reduces battery life.

### BRIEF DESCRIPTION OF THE DRAWINGS

FIG. 1 shows a laser drive apparatus with multiple programmable switching power supplies and multiple drive transistors;

FIG. 2 shows power supply voltages and time durations in accordance with various embodiments of the present invention;

FIG. 3 shows an example embodiment of a control and pulse width modulation (PWM) circuit;

FIG. 4 shows a laser drive apparatus with a calibration circuit;

FIG. 5 shows a laser drive apparatus with a dither circuit;

FIG. 6 shows an example embodiment of a dither circuit;

FIG. 7 shows waveforms in accordance with operation of a dither circuit;

FIG. 8 shows a color laser projection apparatus;

FIG. 9 shows a block diagram of a mobile device in accordance with various embodiments of the present invention;

FIG. 10 shows a mobile device in accordance with various embodiments of the present invention; and

FIG. 11 shows a flowchart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

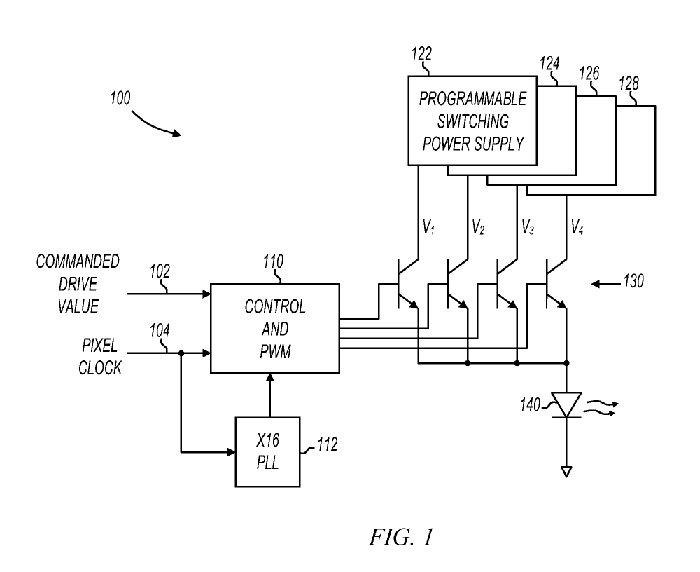

FIG. 1 shows a laser drive apparatus with multiple programmable switching power supplies and multiple drive transistors. Apparatus 100 includes programmable switching power supplies 122, 124, 126, and 128, transistors 130, control and pulse width modulation (PWM) circuit 110, phase locked loop (PLL) 112, and light source 140. Each of power supplies 122, 124, 126, and 128 provides a different power supply voltage to a corresponding one of transistors 130, which are in turn coupled to provide a drive signal to light source 140. In some embodiments, transistors 130 are switching transistors that are turned fully on or fully off. When on, the transistors have a very small voltage drop and dissipate very little power. This allows for very efficient operation.

In some embodiments, light source 140 is a laser light source. For example, in some embodiments light source 140 is a laser diode that produces red, green, or blue laser light. Light source 140 is not limited to laser embodiments. For example, other light sources, such as color filters or light emitting diodes (LEDs) or edge-emitting LEDs, could easily be substituted.

In operation, control and PWM circuit 110 receives a commanded drive value on node 102 in the form of a digital word. In response to the commanded drive value, control and PWM circuit 110 selects one of transistors 130 to drive light source 140. Control and PWM circuit 110 also determines a time duration to turn on the selected transistor. By selecting drive transistors with different power supply voltages, and modulating the pulse width (time duration to turn on selected transistor), a variety of laser light output levels (referred to herein as “gray levels” or “grayscale”) can be produced using highly efficient switching transistors, thereby saving system power.

The commanded drive value represents a desired output luminance for a particular amount of time (e.g., one pixel). When the commanded drive value represents one pixel of a video display, the commanded value changes at the pixel rate. Control and PWM circuit 110 receives a pixel clock on node 104. Control and PWM circuit 110 also receives a clock at 16 times the frequency of the pixel clock from PLL 112. In embodiments employing an X16 PLL, control and PWM circuit 110 is able to generate sixteen different pulse widths per pixel. This represents up to four bits of grayscale.

In some embodiments, PLL 112 multiplies the pixel clock by a factor other than sixteen. For example, PLL 112 may multiply the pixel clock by eight, thereby providing three bits of grayscale resolution through pulse width modulation. PLL 112 may multiply the pixel clock by any factor and any number of bits of resolution may be provided by pulse width modulation without departing from the scope of the present invention. The number of possible pulse widths is not limited to a power of two. For example, in some embodiments, thirteen different pulse widths are possible per pixel.

Programmable switching power supplies 122, 124, 126, and 128 are shown providing power supply voltages V₁, V₂, V₃, and V₄ to four different selectable transistors. This provides up to two bits of grayscale resolution. In some embodiments, more or less transistors 130 are included. For example, in some embodiments, two transistors 130 and two programmable switching power supplies are included. In these embodiments, up to one bit of grayscale resolution is provided. Also for example, in some embodiments, eight transistors 130 and eight programmable switching power supplies are included. In these embodiments, up to three bit of grayscale resolution is provided. Any number of transistors 130 and power supplies may be included without departing from the scope of the present invention. It is not necessary that the number of transistors be equal to a power of 2. For example, some embodiments may include seven transistors 130.

Embodiments that have sixteen possible pulse width values and four transistors 130 can provide up to six bits of grayscale resolution. For example, and not by way of limitation, the power supply voltages may be set to voltages that produce drive currents of 25 ma, 50 ma, 75 ma, and 100 ma. Also for example, the transistor supplying the drive current may be turned on for any duration between O-15 ns in 1 ns steps. The total deposited charge is the product of these two, which provides a total of 64 gray levels, or 6 bits of grayscale resolution. As described above, the grayscale resolution may be increased by providing more transistors 130 and/or more pulse width values. Some embodiments provide more grayscale resolution by dithering the digital input. These embodiments are described further below with reference to later figures.

The power supply voltages may have any relationship to each other. For example, in some embodiments, the power supply voltages may be set such that each transistor provides a non-overlapping range of luminance values over the pulse width range. Also for example, in other embodiments, the power supply voltages may be selected such that the range of luminance values provided by each transistor overlap. The programmable switching power supplies may be any type of switching power supply. For example, the programmable switching power supplies may be pulse width modulating (PWM) power supplies switching at any frequency. Switching power supplies are generally known in the art, and the various embodiments of the present invention are not limited by the implementation details of programmable switching power supplies 122, 124, 126, and 128.

Transistors 130 are shown as bipolar junction transistor (BJT), although this is not a limitation of the present invention. Any switching device suitable to provide current to a light source may be substituted therefor and is considered equivalent. For example, a field effect transistor (FET) such as a junction FET (JFET) or metal oxide semiconductor FET (MOSFET) may be utilized for transistors 130 without departing from the scope of the present invention.

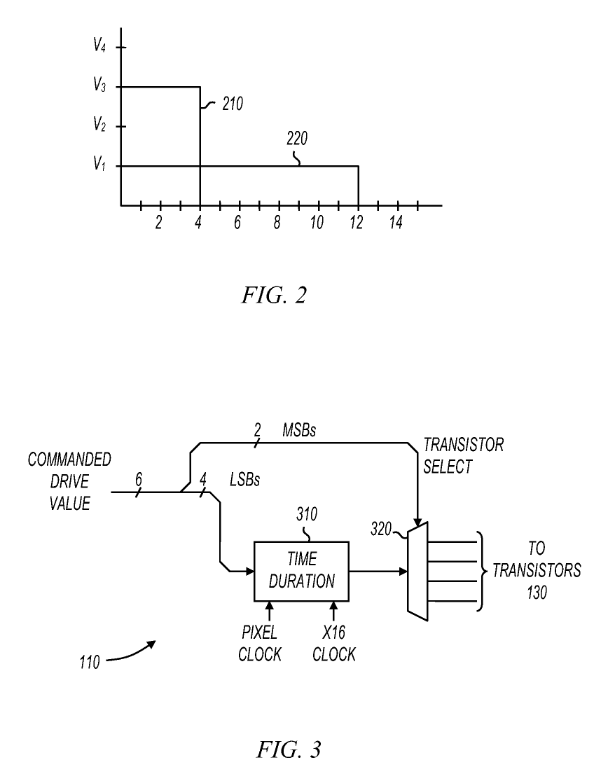

FIG. 2 shows power supply voltages and time durations in accordance with various embodiments of the present invention. The vertical axis of FIG. 2 shows four different power supply voltages and the horizontal axis shows sixteen possible pulse width values (zero to fifteen). Rectangle 210 corresponds to the transistor 130 having power supply voltage V₃ being turned on for a time duration equal to a pulse width of three. Rectangle 220 corresponds to the transistor 130 having power supply voltage V₁ being turned on for a time duration equal to a pulse width of twelve. Any drive transistor coupled to receive any power supply voltage may be selected for any time duration without departing from the scope of the present invention.

FIG. 3 shows an example embodiment of a control and pulse width modulation (PWM) circuit. Control and PWM circuit 110 includes decoder 320 and time duration circuit 310. In the example of FIG. 3, the commanded luminance value is a six bit digital word. The two most significant bits (MSBs) of the digital word select which transistor to turn on using decoder 320. The four least significant bits (LSBs) of the digital word are used to determine the time duration for which to turn on the selected transistor.

Various embodiments of the invention determine the time duration and select the transistor to turn on in different ways. For example, for a six bit commanded luminance value, two MSBs may be used to select the transistor, while five LSBs may be used to determine the time duration. This provides for overlap between the grayscale provided by each transistor.

The various embodiments of the present invention are not limited to six bit commanded drive values. For example, in some embodiments, the commanded drive value includes eight bits. In some of these embodiments, two MSBs are used to select a transistor and in other of these embodiments, three MSBs are used to select a transistor. For any digital word size commanded drive value, any number of bits may be used to select a transistor, and any number of bits may be used to determine a pulse width without departing from the scope of the present invention.

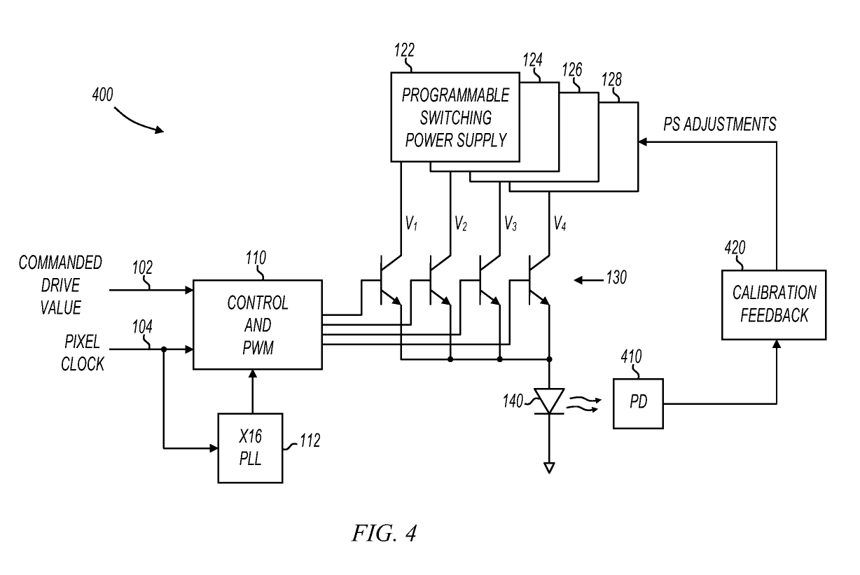

FIG. 4 shows a laser drive apparatus with a calibration circuit. Laser drive apparatus 400 includes all elements shown in FIG. 1. Laser drive apparatus 400 also includes photodetector 410 and calibration feedback circuit 420. In operation, photodetector 410 detects the amount of light produced by light source 140. Calibration feedback circuit 420 receives from photodetector 410 an indication of the amount of light produced, and provides power supply adjustment feedback to programmable switching power supplies 122, 124, 126, and 128.

The power supply voltage values needed to produce specific currents (and light levels) may be learned by asserting values within each of the four transistors' grayscale ranges, and slowly adjusting the power supplies to maintain suitable power supply voltages. In some embodiments, these calibration pulses are sent at times that the light source would otherwise be inactive. For example, in video applications, a calibration pulse may be sent at the top or bottom of the video frame. Calibration feedback circuit 420 may include any suitable loop filter for feedback. For example, calibration feedback circuit 420 may include a proportional-integral-derivative (PID) controller that is updated when the calibration pulses are issued.

Because the calibration feedback loop operates relatively slowly, in some embodiments, a microprocessor may be in the loop. For example, calibration feedback circuit 420 may include a processor or controller that executes instructions to adjust the power supplies in response to the measured light output.

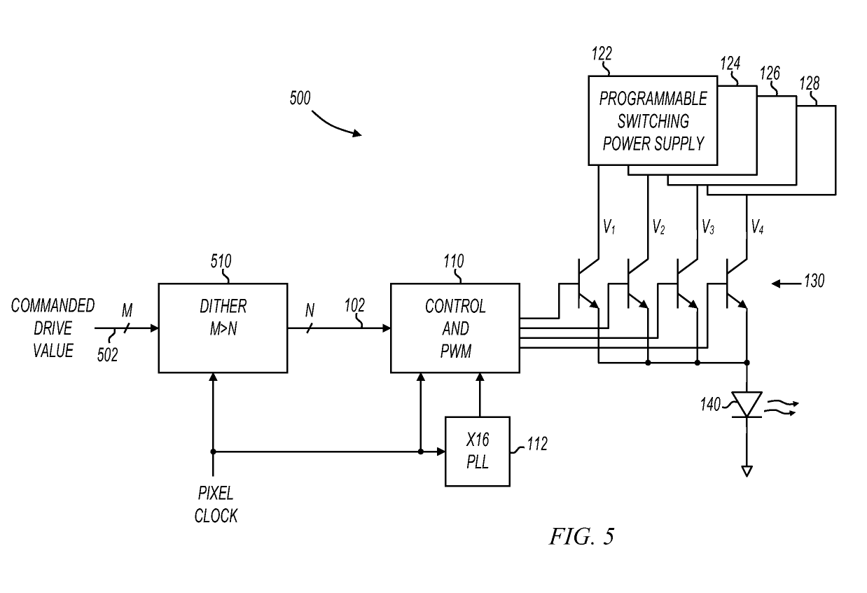

FIG. 5 shows a laser drive apparatus with a dither circuit. Laser drive apparatus 500 includes all elements shown in FIG. 1. Laser drive apparatus also includes dither circuit 510. Dither circuit 510 receives the commanded drive value on node 502 and provides a digital word to control and PWM circuit 110 on node 102.

The commanded drive value on node 502 is a digital word having M bits, and the digital word on node 102 has N bits, where M is greater than N. In operation, dither circuit 510 receives an M bit input word and produces an N bit output word by truncating the input. The truncated bits are added to the next input value and the process repeats. When each input value is truncated, a lesser value output (corresponding to a dimmer light output) results, but the truncated bits increase the value of a later output.

As an example, consider the case in which M=10 and N=4. The commanded drive value can range from zero to 1023, however there are only 16 possible output values: 0, 64, 128, 192, 256, 320, 384, 448, 512, 576, 640, 704, 768, 832, 896, and 960; corresponding to zero through 15 on the N-bit output. Input values from zero to 63 are truncated down to an output value of zero. Similarly, input values from 64 to 127 are truncated down to an output value of 64.

The difference between the input values and the truncated output values is referred to herein as the “residual.” The residual is added to the next input value. For example, if the input value is 522, the truncated output value is 512 and the residual of 10 is added to the next input value.

As another example, consider a consecutive string of input values of 48. The corresponding string of output values will be 0, 64, 64, 64, 0, 64, 64, 64, etc. The average output value is 48.

Because of the truncation, the output value cannot accommodate values over 960. In some embodiments, dither circuit 510 scales the input value down by 960/1023 so that the full range of input values is represented by the full range of possible output values. In other embodiments, dither circuit 510 includes limiting logic to limit the input value to the maximum truncated value, in this example, 960.

In some embodiments, dither circuit 510 employs a “look-ahead” feature that looks at future commanded drive values when producing the current output value. For example, a moving average filter may be employed prior to truncation. In other embodiments, a random number generator weighted by the residual is used to determine which of two adjacent output values will be generated. In still further embodiments, temporal dithering is employed. Any type of dithering may be used to reduce the M-bit commanded drive value to an N-bit drive value without departing from the scope of the present invention.

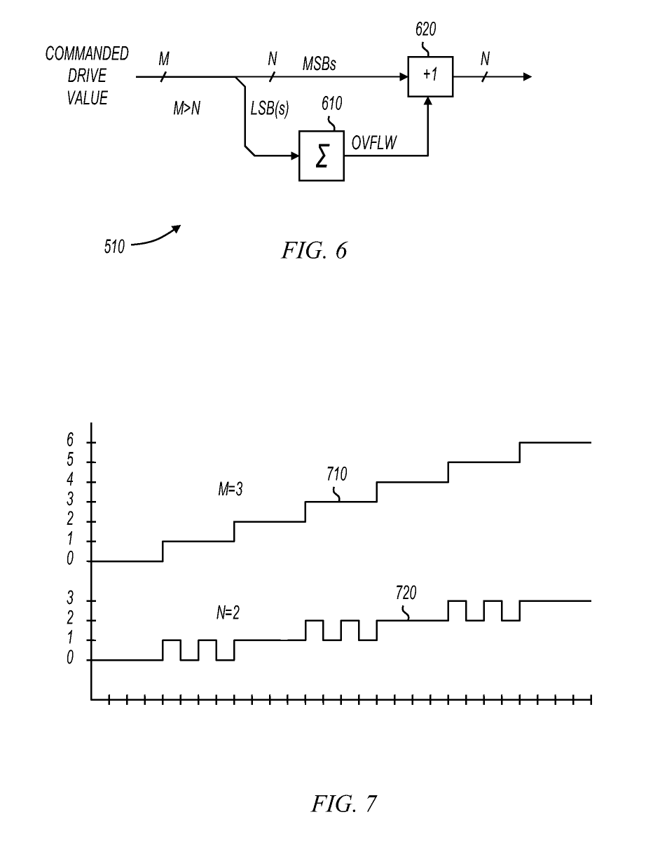

FIG. 6 shows an example embodiment of a dither circuit. Dither circuit 510 includes accumulator 610 and incrementer 620. As described above with reference to FIG. 5, dither circuit 510 receives an M-bit digital input word and produces an N-bit digital output word, where M is greater than N.

In the example dithering circuit of FIG. 6, the M-bit input value is truncated to N bits, and the truncated LSBs form the residual. The residual values are accumulated by accumulator 510. When accumulator 510 overflows, incrementer 620 adds one to the N-bit output value. M and N can take on any values. In some embodiments, dither circuit 510 includes a scaling circuit to scale the maximum input value to the maximum output value.

FIG. 7 shows waveforms in accordance with operation of a dither circuit. Waveforms 710 and 720 show operation of a dither circuit where M=3 and N=2. This is a simplified example to demonstrate dither circuit operation when only one bit is truncated. The input value can range from zero to seven, and the output value can range from zero to three. Waveform 710 is shown incrementing from zero to six.

Each tick on the horizontal axis represent one pixel time. When the input value is zero, the output value is also zero. When the input value is one, the output alternates between zero and one as the accumulator overflows. For this example where M=3 and N=2, odd input values cause the output to dither between two output values. In the simplified example of FIG. 7, the output cannot represent values corresponding to an input value of seven. In some embodiments, the output is limited to the values shown, and an input value of seven is limited to six. In other embodiments, the input value is scaled by 6/7 so that all possible input values can be represented by a two-bit output digital word.

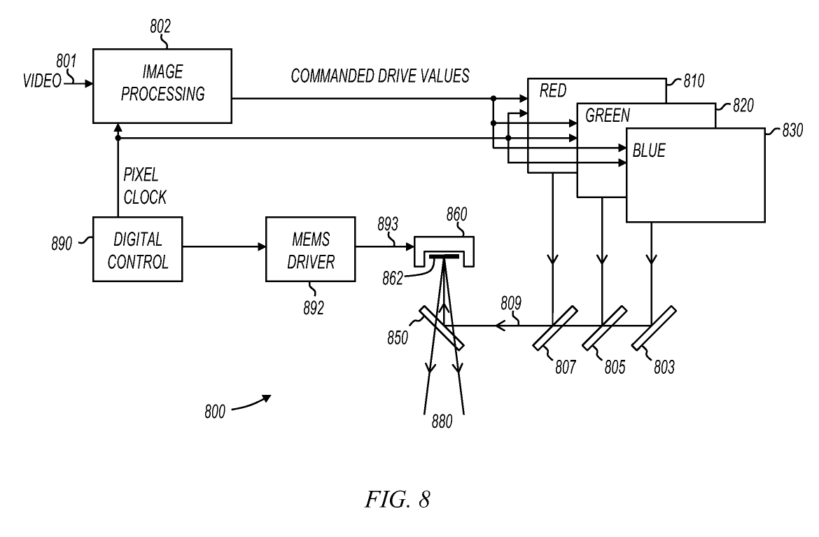

FIG. 8 shows a color laser projection apparatus. System 800 includes image processing component 802, laser light sources 810, 820, and 830. Projection system 800 also includes mirrors 803, 805, and 807, filter/polarizer 850, micro-electronic machine (MEMS) device 860 having mirror 862, MEMS driver 892, and digital control component 890.

In operation, image processing component 802 receives video data on node 801, receives a pixel clock from digital control component 890, and produces commanded drive values to drive the laser light sources when pixels are to be displayed. Image processing component 802 may include any suitable hardware and/or software useful to produce commanded drive values from video data. For example, image processing component 802 may include application specific integrated circuits (ASICs), one or more processors, or the like.

Laser light sources 810, 820, and 830 receive commanded drive values and produce light. Laser light sources 810, 820, and 830 may include any of the laser drive apparatus described herein. For example, laser light sources 810, 820, and 830 may include any of apparatus 100 (FIG. 1), 400 (FIG. 4), or 500 (FIG. 5).

Each light source produces a narrow beam of light which is directed to the MEMS mirror via guiding optics. For example, blue laser light source 830 produces blue light which is reflected off mirror 803 and is passed through mirrors 805 and 807; green laser light source 820 produces green light which is reflected off mirror 805 and is passed through mirror 807; and red laser light source 810 produces red light which is reflected off mirror 807. At 809, the red, green, and blue light are combined. The combined laser light is reflected off fold mirror 850 on its way to MEMS mirror 862. The MEMS mirror rotates on two axes in response to electrical stimuli received on node 893 from MEMS driver 892. After reflecting off MEMS mirror 862, the laser light bypasses fold mirror 850 to create an image at 880.

The image at 880 may include image artifacts that result from dithering within laser light sources 810, 820, and 830. For example, a faint denim-like pattern may appear when residuals occur with some spatial frequency. These artifacts are most likely to be visible within homogeneous regions of static video. In some embodiments the patterns are kept from moving by clearing the residual value at the end of every frame. This ensures that consecutive static frames are rendered identically. In some embodiments, the pattern are allowed to move from frame to frame. For example, in some embodiments, the residual is retained at the end of every frame. In further embodiments, the residual is randomized at the end of every frame. These artifacts can also be reduced by reducing the dither magnitude (e.g., dither to eight bits rather than six bits).

The MEMS based projector is described as an example application, and the various embodiments of the invention are not so limited. For example, the laser drive apparatus described herein may be used with other optical systems without departing from the scope of the present invention.

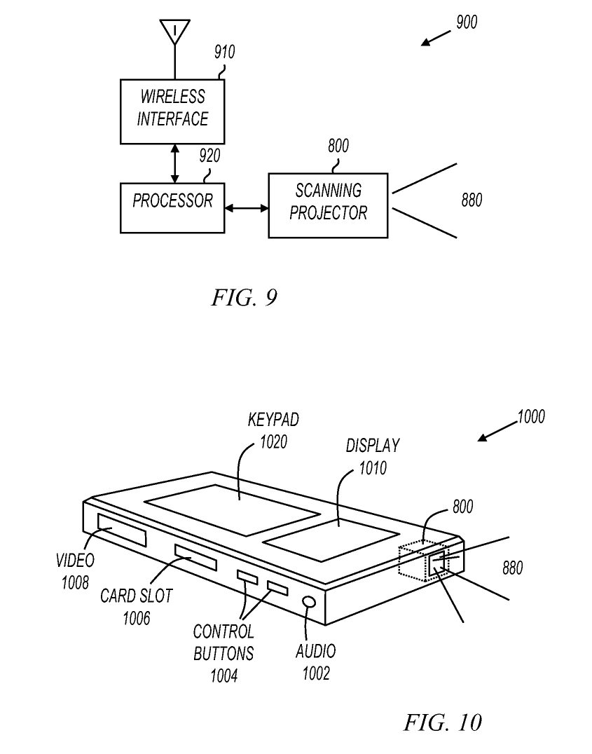

FIG. 9 shows a block diagram of a mobile device in accordance with various embodiments of the present invention. As shown in FIG. 9, mobile device 900 includes wireless interface 910, processor 920, and scanning projector 800. Scanning projector 800 paints a raster image at 880. Scanning projector 800 is described with reference to FIG. 8. In some embodiments, scanning projector 800 includes one or more laser drive apparatus with multiple selectable transistors coupled to different power supply voltages, such as those shown in, and described with reference to, earlier figures.

Scanning projector 800 may receive image data from any image source. For example, in some embodiments, scanning projector 800 includes memory that holds still images. In other embodiments, scanning projector 800 includes memory that includes video images. In still further embodiments, scanning projector 800 displays imagery received from external sources such as connectors, wireless interface 910, or the like.

Wireless interface 910 may include any wireless transmission and/or reception capabilities. For example, in some embodiments, wireless interface 910 includes a network interface card (NIC) capable of communicating over a wireless network. Also for example, in some embodiments, wireless interface 910 may include cellular telephone capabilities. In still further embodiments, wireless interface 910 may include a global positioning system (GPS) receiver. One skilled in the art will understand that wireless interface 910 may include any type of wireless communications capability without departing from the scope of the present invention.

Processor 920 may be any type of processor capable of communicating with the various components in mobile device 900. For example, processor 920 may be an embedded processor available from application specific integrated circuit (ASIC) vendors, or may be a commercially available microprocessor. In some embodiments, processor 920 provides image or video data to scanning projector 800. The image or video data may be retrieved from a wired or wireless interface 910 or may be derived from data retrieved from wireless interface 910. For example, through processor 920, scanning projector 800 may display images or video received directly from wireless interface 910. Also for example, processor 920 may provide overlays to add to images and/or video received from wireless interface 910, or may alter stored imagery based on data received from wireless interface 910 (e.g., modifying a map display in GPS embodiments in which wireless interface 910 provides location coordinates).

FIG. 10 shows a mobile device in accordance with various embodiments of the present invention. Mobile device 1000 may be a hand held projection device with or without communications ability. For example, in some embodiments, mobile device 1000 may be a handheld projector with little or no other capabilities. Also for example, in some embodiments, mobile device 1000 may be a device usable for communications, including for example, a cellular phone, a smart phone, a personal digital assistant (PDA), a global positioning system (GPS) receiver, or the like. Further, mobile device 1000 may be connected to a larger network via a wireless (e.g., WiMax) or cellular connection, or this device can accept data messages or video content via an unregulated spectrum (e.g., WiFi) connection.

Mobile device 1000 includes scanning projector 800 to create an image with light at 880. Mobile device 1000 also includes many other types of circuitry; however, they are intentionally omitted from FIG. 10 for clarity.

Mobile device 1000 includes display 1010, keypad 1020, audio port 1002, control buttons 1004, card slot 1006, and audio/video (A/V) port 1008. None of these elements are essential. For example, mobile device 1000 may only include scanning projector 800 without any of display 1010, keypad 1020, audio port 1002, control buttons 1004, card slot 1006, or A/V port 1008. Some embodiments include a subset of these elements. For example, an accessory projector product may include scanning projector 800, control buttons 1004 and A/V port 1008.

Display 1010 may be any type of display. For example, in some embodiments, display 1010 includes a liquid crystal display (LCD) screen. Display 1010 may always display the same content projected at 880 or different content. For example, an accessory projector product may always display the same content, whereas a mobile phone embodiment may project one type of content at 880 while display different content on display 1010. Keypad 1020 may be a phone keypad or any other type of keypad.

A/V port 1008 accepts and/or transmits video and/or audio signals. For example, A/V port 1008 may be a digital port that accepts a cable suitable to carry digital audio and video data. Further, A/V port 1008 may include RCA jacks to accept composite inputs. Still further, A/V port 1008 may include a VGA connector to accept analog video signals. In some embodiments, mobile device 1000 may be tethered to an external signal source through A/V port 1008, and mobile device 1000 may project content accepted through A/V port 1008. In other embodiments, mobile device 1000 may be an originator of content, and A/V port 1008 is used to transmit content to a different device.

Audio port 1002 provides audio signals. For example, in some embodiments, mobile device 1000 is a media player that can store and play audio and video. In these embodiments, the video may be projected at 880 and the audio may be output at audio port 1002. In other embodiments, mobile device 1000 may be an accessory projector that receives audio and video at A/V port 1008. In these embodiments, mobile device 1000 may project the video content at 880, and output the audio content at audio port 1002.

Mobile device 1000 also includes card slot 1006. In some embodiments, a memory card inserted in card slot 1006 may provide a source for audio to be output at audio port 1002 and/or video data to be projected at 880. Card slot 1006 may receive any type of solid state memory device, including for example, Multimedia Memory Cards (MMCs), Memory Stick DUOS, secure digital (SD) memory cards, and Smart Media cards. The foregoing list is meant to be exemplary, and not exhaustive.

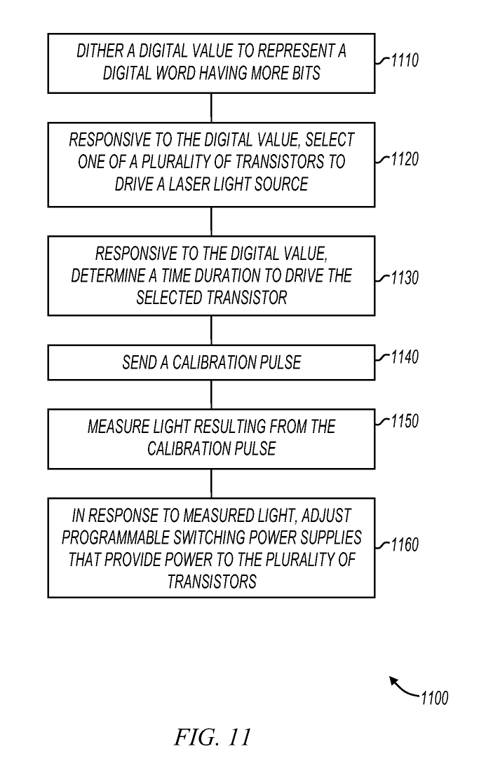

FIG. 11 shows a flowchart in accordance with various embodiments of the present invention. In some embodiments, method 1100, or portions thereof, is performed by a laser drive apparatus, a mobile projector, or the like, embodiments of which are shown in previous figures. In other embodiments, method 1100 is performed by an integrated circuit or an electronic system. Method 1100 is not limited by the particular type of apparatus performing the method. The various actions in method 1100 may be performed in the order presented, or may be performed in a different order. Further, in some embodiments, some actions listed in FIG. 11 are omitted from method 1100.

Method 1100 is shown beginning with block 1110 in which a digital value is dithered to represent a digital word having more bits. For example, a six bit output value may be dithered to represent a ten bit input value. Any of the dithering embodiments described above may be used to dither the digital value.

At 1120, one of a plurality of transistors is selected to drive a laser light source in response to the digital value, and at 1130, a time duration to drive the selected transistor is determined responsive to the digital value. For example, in some embodiments, MSBs of the digital value may be used to select a transistor, and LSBs of the digital value may be used to determine a time duration.

At 1140, a calibration pulse is sent. In some embodiments, calibration pulses are sent during inactive video periods in a scanning laser projector. For example, calibration pulses may be sent at the end of video frames. Calibration pulses may always have the same drive values, or may have varying drive values.

At 1150, light resulting from the calibration pulse is measured. Referring back to FIG. 4, photodetector 410 measures the amount of light produced by a calibration pulse. At 1160, programmable switching power supplies that provide power to the plurality of transistors are adjusted in response to the measured light. This corresponds to calibration feedback circuit 420 adjusting power supplies 122, 124, 126, and 128 as described above.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. An apparatus comprising:
a plurality of power supplies;
a plurality of transistors, each of the plurality of transistors being coupled to a corresponding one of the plurality of power supplies; and
a control circuit to select, in response to a digital word, one of the plurality of transistors to turn on and to select a time duration for which the one of the plurality of transistors is to be turned on.

2. The apparatus of claim 1 further comprising a laser light source coupled to be driven by the plurality of transistors.

3. The apparatus of claim 2 wherein the laser light source comprises a laser diode.

4. The apparatus of claim 2 further comprising a calibration circuit to adjust power supply voltages provided by the plurality of power supplies.

5. The apparatus of claim 4 wherein the calibration circuit includes a photodetector to detect light output from the laser light source.

6. The apparatus of claim 4 wherein the plurality of transistors includes four transistors and the plurality of power supplies comprises four power supplies.

7. The apparatus of claim 1 wherein the plurality of power supplies are switching power supplies.

8. The apparatus of claim 1 wherein two bits of the digital word are used by the control circuit to select the one of the plurality of transistors to turn on and a remainder of bits in the digital word are used by the control circuit to select the time duration.

9. The apparatus of claim 1 further comprising a dithering circuit to provide the digital word in response to a second digital word having more bits than the digital word.

10. The apparatus of claim 9 wherein the dithering circuit comprises an accumulator to accumulate least significant bit values of the second digital word, and to modify the digital word in response thereto.

11. An apparatus comprising:
a laser diode to produce laser light in response to a current;
a laser drive apparatus to drive the laser diode with the current, the laser drive apparatus including a plurality of selectable transistors separately coupled to receive a plurality of different power supply voltages;
a light measurement circuit to measure light from the laser diode; and
a plurality of programmable switching power supplies coupled to provide the plurality of different power supply voltages to the laser drive apparatus, wherein the programmable switching power supplies are coupled to be responsive to the light measurement circuit.

12. The apparatus of claim 11 further comprising a control circuit to select one of the plurality of selectable transistors in response to a digital word.

13. The apparatus of claim 12 wherein the plurality of selectable transistors includes four transistors, and the control circuit is operable to select the one of the plurality of selectable transistors in response to two bits of the digital word.

14. The apparatus of claim 12 wherein the control circuit determines a time duration for which the one of the plurality of selectable transistors is turned on.

15. The apparatus of claim 14 wherein the control circuit is operable to determine the time duration in response to the least significant bits of the digital word.

16. The apparatus of claim 12 further comprising a dithering circuit to produce the digital word from a commanded drive value having more bits than the digital word.

17. A mobile device comprising:
a communications transceiver; and
a projection apparatus that includes a MEMS mirror to scan laser light on two axes, and at least one laser light source to produce the laser light, the laser light source having a laser drive apparatus that includes a plurality of drive transistors coupled to different power supply voltages and a control circuit to select one of the plurality of transistors to turn on to drive the laser light source.

18. The mobile device of claim 17 further comprising a dithering circuit to receive a first digital word having a first number of bits representing a commanded drive value, the dithering circuit to provide a second digital word having fewer bits than the first digital word to the control circuit.

19. The mobile device of claim 18 wherein the dithering circuit includes an accumulator to accumulate least significant bits of the first digital word.

20. The mobile device of claim 17 further comprising:
a plurality of programmable switching power supplies to provide the plurality of different power supply voltages; and
a calibration circuit to measure the laser light and influence operation of the plurality of programmable switching power supplies.
